(19) United States
(12) Patent Application Publication
(10) Pub. No.: US 2017/0280046 A1
(43) Pub. Date: Sep. 28, 2017

(54) METHOD AND MOBILE DEVICE FOR SWITCHING CAMERA MODE

(71) Applicants: Le Holdings (Beijing) Co., Ltd., Beijing (CN); Lemobile Information Technology (Beijing) Co., Ltd., Beijing (CN)

(72) Inventor: Haosen Suo, Beijing (CN)

(21) Appl. No.: 15/355,035

(22) Filed: Nov. 17, 2016

Related U.S. Application Data
(63) Continuation of application No. PCT/CN2016/096423, filed on Aug. 23, 2016.

(30) Foreign Application Priority Data
Mar. 25, 2016 (CN) 2016101800855

(51) Int. Cl. H04N 5/232

(52) U.S. Cl. CPC H04N 5/23216; H04N 5/23245

(57) ABSTRACT

Disclosed are a method and mobile device for switching camera mode. The method for switching camera mode includes the steps of: detecting an operation information of a user at an edge touch area of the mobile device in an on state of a camera of the mobile device; and switching the mode of the camera according to the operation information, so that the mode of the camera of the mobile device can be switched by one operation action of the user at the edge touch area of the mobile device, the operation process is simple and fast, the switching speed is improved, the user experience is promoted, and the user satisfaction is improved. Thus, the technical solutions provided by the embodiments of the present disclosure can solve the problems that the scene mode switching operation process of the camera function of the mobile device is complex, fussy and slow.

### CROSS REFERENCE TO RELATED APPLICATIONS

This application is a continuation of International Application No. PCT/CN2016/096423, filed on Aug. 23, 2016, which is based upon and claims priority to Chinese Patent Application No. 2016101800855, filed on Mar. 25, 2016, the entire contents of which are incorporated herein by reference.

### TECHNICAL FIELD

The present disclosure relates to the technical field of communications, and particularly relates to a method and mobile device for switching camera mode.

### BACKGROUND

The camera function is a frequently used function in people's work and life. In order to facilitate use, the camera function is integrated on portable mobile device, such as a mobile phone, a tablet computer and the like.

At present, the camera function of the mobile device generally has multiple scene modes, e.g., a night scene mode, a panoramic mode, a figure mode, a micro-distance mode, etc. If the scene modes of a camera are switched, a virtual icon for managing the scene modes of the camera needs to be found on the screen of the mobile device in a state that the camera function of the mobile device is opened, then the virtual icon is clicked, all scene modes are displayed on the screen of the mobile device, and a user selects one scene mode and clicks OK to switch to the desired camera scene mode. Moreover, in this process, one hand of the user needs to hold the mobile device, while the other hand carries out operation on the screen of the mobile device.

In the process of implementing the present application, the inventor discovers that the prior art at least has the following problems:

The operation process of scene mode switching of the camera function of the mobile device is complex, fussy and slow.

### SUMMARY

In view of this, the present disclosure provides a method and mobile device for switching camera mode to solve the problems that the operation process of scene mode switching of the camera function of the mobile device is complex, fussy and slow.

On one aspect, an embodiment of the present disclosure provides a method for switching camera mode applied to a mobile device, including: detecting an operation information of a user at an edge touch area of the mobile device in an on state of a camera of the mobile device; and switching the mode of the camera according to the operation information.

According to the above aspect and any possible implementation way, an implementation way is further provided, wherein the switching the mode of the camera according to the operation information includes: under the condition that the operation information is a touch at a preset position of the edge touch area by the user, switching the camera to the mode corresponding to the preset position according to the touch.

According to the above aspect and any possible implementation way, an implementation way is further provided, wherein the switching the mode of the camera according to the operation information includes: under the condition that the operation information is sliding of a finger at the edge touch area, switching the camera to a next or last adjacent mode of a current mode according to the sliding.

According to the above aspect and any possible implementation way, an implementation way is further provided, wherein the sliding is up-down sliding of the thumb at the edge touch area of the left border or the right border of the mobile device.

According to the above aspect and any possible implementation way, an implementation way is further provided, wherein the sliding is left-right sliding of the index finger at the edge touch area of the upper border of the mobile device.

According to the above aspect and any possible implementation way, an implementation way is further provided, wherein the edge touch area is located at the side border of the mobile device.

Any of the above technical solutions has the following beneficial effects.

According to the method for switching camera mode of the embodiment of the present disclosure, the mode of the camera of the mobile device can be switched by one operation action of the user at the edge touch area of the mobile device, so the operation process is simple and fast, the switching speed is improved, then the use experience of the user is promoted, and the user satisfaction is improved.

On a further aspect, an embodiment of the present disclosure provides a mobile device, including a processor and a memory which is used for storing instructions executable by the processor; the processor is configured to: detect an operation information of a user at an edge touch area of the mobile device in an on state of a camera of the mobile device; and switch the mode of the camera according to the operation information.

According to the above aspect and any possible implementation, an implementation way is further provided, wherein the mobile device is a mobile phone or a tablet computer.

Any of the above technical solutions has the following beneficial effects:

The mobile device of the embodiment of the present disclosure can execute the aforementioned camera mode switching method, and the mode of the camera of the mobile device can be switched by one operation action of the user at the edge touch area of the mobile device, so the operation process is simple and fast, the switching speed is improved, then the use experience of the user is promoted, and the user satisfaction is improved.

On a further aspect, an embodiment of the present disclosure provides a non-transient computer readable storage medium, which stores computer executable instructions, the computer executable instructions are used for: detecting an operation information of a user at an edge touch area of the mobile device in an on state of a camera of the mobile device; and switching the mode of the camera according to the operation information.

The non-transient computer readable storage medium of the embodiment of the present disclosure can execute the aforementioned camera mode switching method, and the mode of the camera of the mobile device can be switched by one operation action of the user at the edge touch area of the mobile device, so the operation process is simple and fast, the switching speed is improved, then the use experience of the user is promoted, and the user satisfaction is improved.

On a further aspect, an embodiment of the present disclosure provides a computer program product, the computer program product includes a computer program stored on a non-transient computer readable storage medium, the computer program includes program instructions, and when the program instructions are executed by a computer, the computer executes the above methods.

The computer program product of the embodiment of the present disclosure can execute the aforementioned camera mode switching method, and the mode of the camera of the mobile device can be switched by one operation action of the user at the edge touch area of the mobile device, so the operation process is simple and fast, the switching speed is improved, then the use experience of the user is promoted, and the user satisfaction is improved.

### BRIEF DESCRIPTION OF THE DRAWINGS

One or more embodiments are illustrated by way of examples via figures in corresponding drawings, these illustrations do not limit the embodiments, components with the same reference numerical signs in the drawings represent similar elements, and the pictures in the drawings do not have proportional limitations unless otherwise specified.

FIG. 1 is a flow schematic diagram of embodiment 1 of a method for switching camera mode provided by some embodiments of the present disclosure;

FIG. 2 is a schematic diagram of a side border of a mobile phone in some embodiments of the present disclosure;

FIG. 3 is a flow schematic diagram of embodiment 2 of a method for switching camera mode provided by some embodiments of the present disclosure;

FIG. 4 is a flow schematic diagram of embodiment 3 of a method for switching camera mode provided by some embodiments of the present disclosure;

FIG. 5 is a functional block diagram of an apparatus for switching camera mode provided by some embodiments of the present disclosure;

FIG. 6 is a structural schematic diagram of a mobile device provided by some embodiments of the present disclosure.

### DETAILED DESCRIPTION

Preferred embodiments of the present disclosure will be illustrated below in combination with the accompanying drawings. It should be understood that the preferred embodiments described herein are merely used for illustrating and interpreting the present disclosure, rather than limiting the present disclosure.

In order to better understand the technical solutions of the present disclosure, the embodiments of the present disclosure will be described in detail below in combination with the accompanying drawings.

It should be clear that the described embodiments are merely part of, not all of the embodiments of the present disclosure. Based on the embodiments in the present disclosure, all other embodiments obtained by those of ordinary skill in the art without any creative effort shall be within the protection scope of the present disclosure.

The terms used in the embodiments of the present disclosure are for describing specific embodiments only, rather than limiting the present disclosure. Singular forms “one”, “said” and “the” used in the embodiments and the appended claims of the present disclosure also intend to include plural forms, unless the context clearly expresses other meanings.

It should be understood that the term “and/or” used in the present application is merely an association relation for describing associated objects, and can express three relations, for example, A and/or B can express: single A, both A and B, and single B. In addition, the symbol “/” herein generally expresses an “or” relation between consecutive associated objects.

It should be understood that an embodiment may be described by adopting the terms including first, second and third in the embodiments of the present disclosure, but the embodiment should not be limited to these terms. These terms are merely used for distinguishing embodiment from one another. For example, the first embodiment may also be referred to as the second embodiment, and similarly, the second embodiment may also be referred to as the first embodiment, without departing from the scope of the embodiments of the present disclosure.

Upon the context, the word “if” used herein can be interpreted as “at the time of . . . ” or “when . . . ” or “responding to determining” or “responding to detecting”. Similarly, upon the context, the phrase “if determining” or “if detecting (the stated condition or event)” can be interpreted as “when determining” or “responding to determining” or “when detecting (the stated condition or event)” or “responding to detecting (the stated condition or event)”.

### Embodiment 1

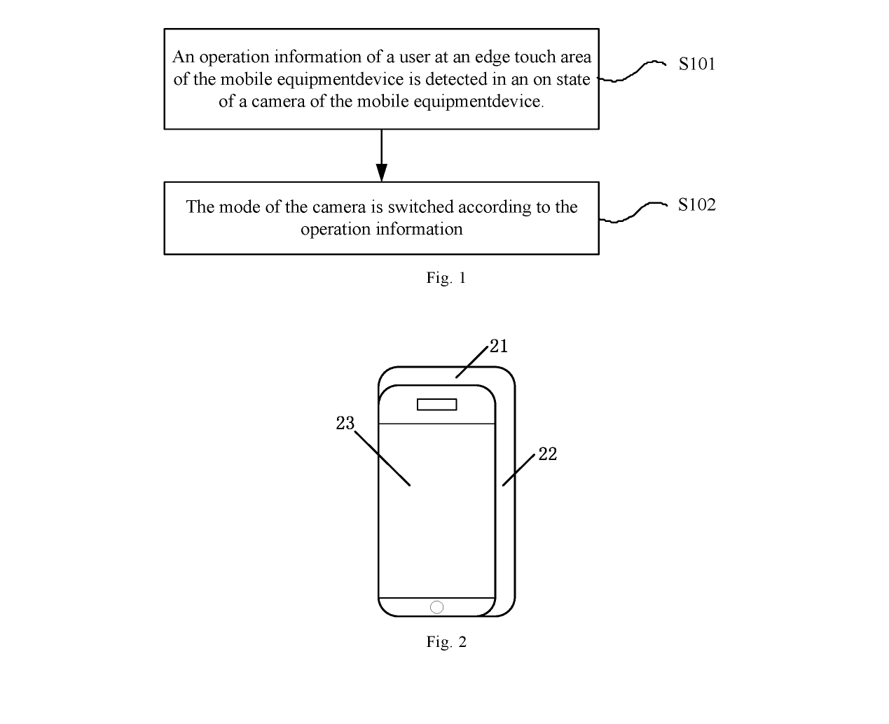

The embodiment of the present disclosure gives a method for switching camera mode, which is applied to a mobile device. Please refer to FIG. 1, which is a flow schematic diagram of a method for switching camera mode provided by an embodiment of the present disclosure. As shown in FIG. 1, the method may include the following steps S101-S102.

S101, an operation information of a user at an edge touch area of the mobile device is detected in an on state of a camera of the mobile device.

It should be noted that the mobile device involved in the embodiments of the present disclosure may include but not limited to a personal computer (PC), a personal digital assistant (PDA), a wireless handheld device, a notebook computer, a tablet computer, a mobile phone, an MP3 player, an MP4 player, etc.

In the embodiment of the present disclosure, the edge touch area may be located at the side border of the mobile device. A mobile phone is taken as an example. FIG. 2 is a schematic diagram of a side border of a mobile phone in the embodiment of the present disclosure. As shown in FIG. 2, the side borders of the mobile phone include an upper border 21, a lower border (not shown in the figure), a left border (not shown in the figure) and a right border 22. The screen 23 of the mobile phone is located on the front side of the mobile phone. The edge touch area may be located at any border or a few borders. For example, the edge touch area may be located at the right border 22, the upper border 21, both the upper borer 21 and the lower border, both the left border and the right border 22, both the upper border 21 and the right border 22, or all of the upper border 21, the lower border, the left border and the right border 22. On each border, the edge touch area can cover all of or part of the area of the border.

Compared with the operation on the front side (e.g., the screen 23 and the surrounding thereof in FIG. 2) of the mobile device, the operation on the border of the mobile device is more comfortable, and can avoid blocking the screen of the mobile device, so that the user can clearly see the content displayed on the screen of the mobile device all the time when he uses the camera of the mobile device, and the user experience is better.

The operation on the border of the mobile device conforms to the people's use habit, and is quite convenient, fast and comfortable. A mode switching instruction can be sent to the camera of the mobile device by only one operation action of the user at the edge touch area of the mobile device. For example, when the right hand holds the mobile phone, the thumb of the right hand slides up or down on the right border of the mobile phone, and the camera is switched to a last or next adjacent mode.

S102, the mode of the camera is switched according to the operation information.

Once the mobile device receives the operation information at the edge touch area, corresponding mode switching is immediately performed on the camera. For example, the camera is switched to a next or last adjacent mode, switched to a mode corresponding to the operation information, etc. In this case, the whole mode switching process only needs one operation of the user, so the operation is very simple and the switching speed is also improved. Moreover, one-hand holding and operation can also be realized in the whole mode switching process. This can meet the requirements of users under some special use scenes and special requirements of some special crowds (e.g., one-arm disabled people).

It should be noted that the execution main body of the above steps S101˜S102 may be an apparatus, which may be an application located on the local device or at a functional unit such as a plug-in or software development kit (SDK) and the like in the application of the local device, and the embodiment of the present disclosure is not specially limited thereto.

It could be understood that the application may be a nativeApp installed on the device or a webApp of a browser on the device, and the embodiment of the present disclosure is not limited thereto.

According to the method for switching camera mode of the embodiment of the present disclosure, the mode of the camera of the mobile device can be switched by one operation action of the user at the edge touch area of the mobile device, so the operation process is simple and fast, the switching speed is improved, then the use experience of the user is promoted, and the user satisfaction is improved. Moreover, the camera mode switching method of the embodiment of the present disclosure can realize one-hand holding and operation during mode switching of the camera of the mobile device, thereby meeting the requirements under some specific application scenes.

### Embodiment 2

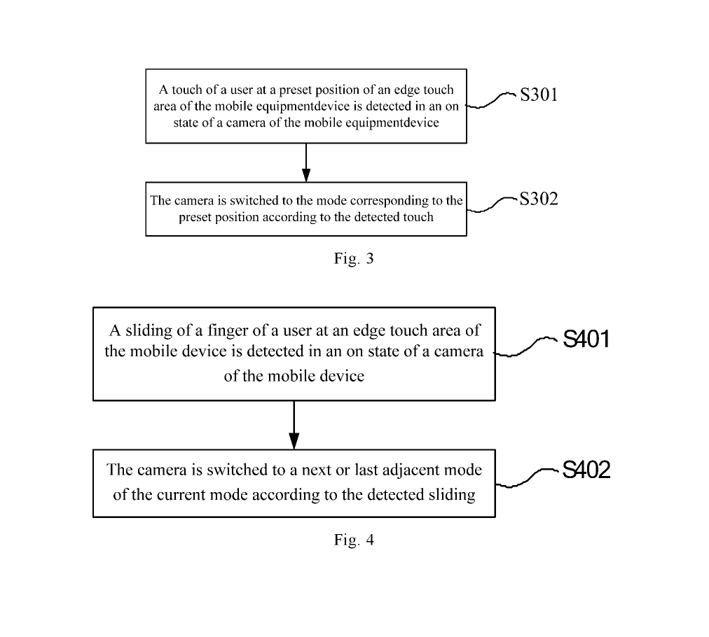

FIG. 3 is a flow schematic diagram of embodiment 2 of a method for switching camera mode provided by an embodiment of the present disclosure, and the method is applied to a mobile device. As shown in FIG. 3, the method for switching camera mode may include the following steps S301˜S302 in this embodiment.

S301, a touch at a preset position of an edge touch area of the mobile device by a user is detected in an on state of a camera of the mobile device.

In this embodiment, the operation information is specifically a touch at the preset position of the edge touch area by a user.

A designated mode corresponding to the specified position of the edge touch area can be preset in the mobile device, so when the user touches the specified position, it is regarded that the user wants to switch to the designated mode corresponding to the specified position. Taking a smart phone as an example, it is supposed that the phone has four modes including a night scene mode, a panoramic mode, a figure mode and a micro-distance mode, and four side borders of the phone are edge touch areas. The phone is preset as follows: the upper half parts of the left and right borders of the phone correspond to the night scene mode, the lower half parts of the left and right borders of the phone correspond to the panoramic mode, the left half part of the upper border of the phone corresponds to the figure mode, and the right half part of the upper border of the phone corresponds to the micro-distance mode. No matter the user holds the phone with left hand or right hand, his thumb can easily and conveniently touch the upper and lower parts of the left or right border of the phone, and the index finger can easily and conveniently touch the left and right half parts of the upper border of the phone. The user desired mode can be switched by touching the specified position of the edge touch area corresponding to the designated mode. For example, if the user wants to switch to the panoramic mode, he only needs to touch the lower half part of the left border (when holding with left hand) or the right border (when holding with right hand) of the phone, and the camera of the phone is immediately switched to the panoramic mode, so the operation with one step is very convenient and fast and the operation process is very simple and easy.

S302, the camera is switched to the mode corresponding to the preset position according to the detected touch.

Here, the specific way of switching the mode of the camera is to switch the camera to the mode corresponding to the preset position according to the detected touch.

According to the method for switching camera mode of the embodiment of the present disclosure, the mode of the camera of the mobile device can be switched by one operation action of the user at the edge touch area of the mobile device, so the operation process is simple and fast, the switching speed is improved, then the use experience of the user is promoted, and the user satisfaction is improved. Moreover, in the camera mode switching method of the embodiment of the present disclosure, the camera can be switched to the user desired mode at one time by touching the specified position of the edge touch area corresponding to the designated mode, so the operation process is very simple and easy, the operation is very convenient and fast, then the switching speed is further improved, the use experience of the user is further prompted, and the user satisfaction is improved.

### Embodiment 3

FIG. 4 is a flow schematic diagram of embodiment 3 of a method for switching camera mode provided by an embodiment of the present disclosure, and the method is applied to a mobile device. As shown in FIG. 4, the method for switching camera mode may include the following steps S401-S402 in this embodiment.

S401, sliding of a user finger at an edge touch area of the mobile device is detected in an on state of a camera of the mobile device.

In this embodiment, the operation information is specifically sliding of the finger at the edge touch area.

The sliding may be up-down sliding of the thumb at the edge touch area of the left border or the right border of the mobile device, or left-right sliding of the index finger at the edge touch area of the upper border of the mobile device. Of course, the specific sliding manner is not limited to the listed ones.

It can be preset in the mobile device that the sliding of user finger at the edge touch area of the mobile device corresponds to camera mode switching according to a set sequence. For example, the switching sequence of a night scene mode, a panoramic mode, a figure mode and a micro-distance mode is: the night scene mode→the panoramic mode→the figure mode→the micro-distance mode→the night scene mode. It is supposed that the finger slides up to realize sequential switching in the arrow direction and slides down to realize sequential switching in the direction opposite to the arrow direction at the edge touch area of the right border of the mobile device, and under the condition that the current camera is in the figure mode, the camera is switched to the micro-distance mode if the user finger slides up at the edge touch area of the right border of the mobile device, and is switched to the panoramic mode if the user finger slides down at the edge touch area of the right border of the mobile device. The user desired mode can be obtained by sliding several times.

For another example, if the finger slides right to realize sequential switching in the arrow direction and slides left to realize sequential switching in the direction opposite to the arrow direction at the edge touch area of the upper border of the mobile device, the camera is switched to the micro-distance mode if the user finger slides right at the edge touch area of the upper border of the mobile device, and is switched to the panoramic mode if the user finger slides left at the edge touch area of the upper border of the mobile device. The user desired mode can also be obtained by sliding several times.

S402, the camera is switched to a next or last adjacent mode of a current mode according to the detected sliding.

In this embodiment, the specific way of switching the mode of the camera is to switch the camera to a next or last adjacent mode of the current mode according to the detected sliding. The user can quickly switch the camera to the desired mode by limited times of sliding.

According to the method for switching camera mode of the embodiment of the present disclosure, the mode of the camera of the mobile device can be switched by one operation action of the user at the edge touch area of the mobile device, so the operation process is simple and fast, the switching speed is improved, then the use experience of the user is promoted, and the user satisfaction is improved. Moreover, in the camera mode switching method of the embodiment of the present disclosure, the camera can be switched to the user desired mode by limited times of very easy sliding operation, so the operation process is very simple and easy, the operation is very convenient and fast, then the switching speed is further improved, the use experience of the user is further prompted, and the user satisfaction is improved.

The present disclosure further gives an apparatus embodiment for implementing the steps and the methods in the above method embodiment.

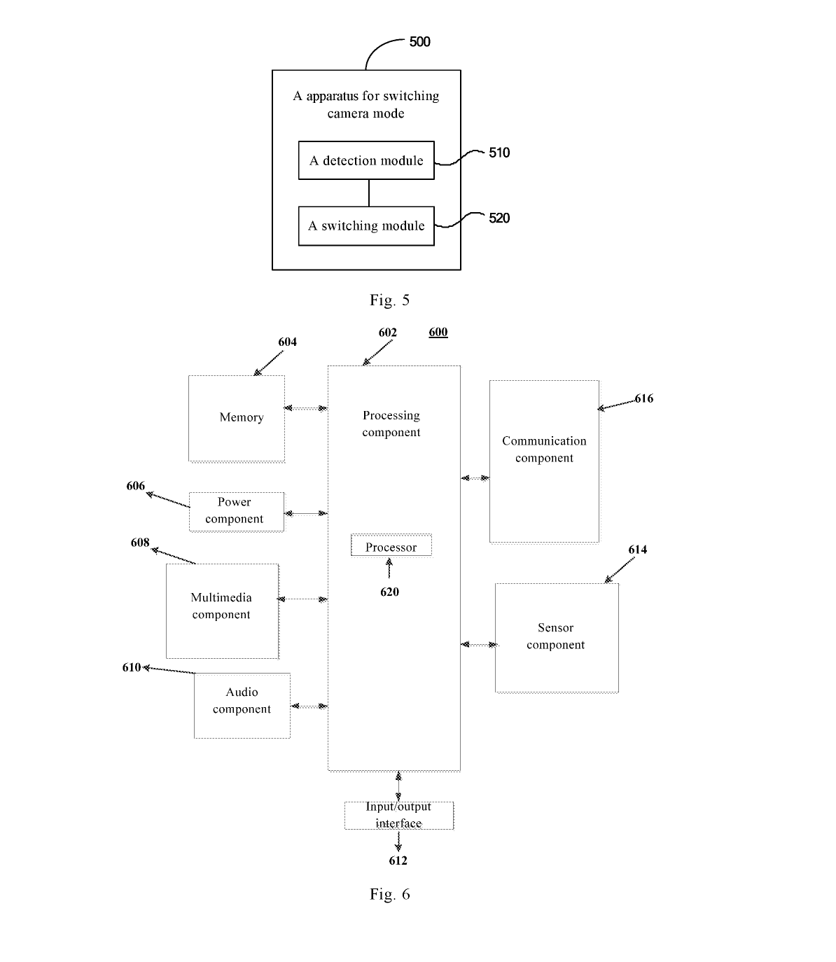

Please refer to FIG. 5, which is a functional block diagram of an apparatus for switching camera mode provided by an embodiment of the present disclosure. As shown in FIG. 5, the apparatus for switching camera mode 500 may include a detection module 510 and a switching module 520 in this embodiment.

The detection module 510 is used for detecting operation information of a user at an edge touch area of mobile device in an on state of a camera of the mobile device. The switching module 520 is used for switching the mode of the camera according to the operation information detected by the detection module 510.

In the embodiment of the present disclosure, the switching module 520 may include a first switching unit. The first switching unit is used for, under the condition that the operation information is a touch at a preset position of the edge touch area by the user, switching the camera to the mode corresponding to the preset position according to the touch. The first switching unit enables the user to switch the camera to the desired mode at one time by touching the specified position of the edge touch area corresponding to the designated mode, so the operation process is very simple and easy, the operation is very convenient and fast, then the switching speed is further improved, the use experience of the user is further prompted, and the user satisfaction is improved.

In the embodiment of the present disclosure, the switching module 520 may include a second switching unit. The second switching unit is used for, under the condition that the operation information is sliding of the finger at the edge touch area, switching the camera to a next or last adjacent mode of the current mode according to the sliding. The second switching unit enables the user to switch the camera to the desired mode by limited times of very easy sliding operation, so the operation process is very simple and easy, the operation is very convenient and fast, then the switching speed is further improved, the use experience of the user is further prompted, and the user satisfaction is improved.

The sliding may be up-down sliding of the thumb at the edge touch area of the left border or the right border of the mobile device, or left-right sliding of the index finger at the edge touch area of the upper border of the mobile device. Of course, the specific sliding mode is not limited to the listed ones.

The edge touch area may be located at the side border of the mobile device.

Since the apparatus for switching camera mode in this embodiment can execute the methods for switching camera mode in the aforementioned embodiments, reference may be made to the relevant description of the aforementioned method embodiments for switching camera mode, for the parts not described in detail in this embodiment.

According to the apparatus for switching camera mode of the embodiment of the present disclosure, the mode of the camera of the mobile device can be switched by one operation action of the user at the edge touch area of the mobile device, so the operation process is simple and fast, the switching speed is improved, then the use experience of the user is promoted, and the user satisfaction is improved.

An embodiment of the present disclosure further provides a non-transient computer readable storage medium, and the non-transient computer readable storage medium stores computer executable instructions, which can execute the method in any above method embodiment.

An embodiment of the present disclosure further provides mobile device, including a processor and a memory. The memory is used for storing processor executable instructions; and the processor is configured to: detect an operation information of a user at an edge touch area of the mobile device in an on state of a camera of the mobile device; and switch the mode of the camera according to the operation information.

The mobile device may be a mobile phone, a tablet computer or the like.

The switching the mode of the camera according to the operation information may include:

under the condition that the operation information is a touch at a preset position of the edge touch area by the user, switching the camera to the mode corresponding to the preset position according to the touch.

The switching the mode of the camera according to the operation information may include:

under the condition that the operation information is sliding of the finger at the edge touch area, switching the camera to a next or last adjacent mode of the current mode according to the sliding.

The sliding may be up-down sliding of the thumb at the edge touch area of the left border or the right border of the mobile device.

The sliding may be left-right sliding of the index finger at the edge touch area of the upper border of the mobile device.

The edge touch area may be located at the side border of the mobile device.

Please refer to FIG. 6, which is a structural schematic diagram of mobile device provided by an embodiment of the present disclosure. As shown in FIG. 6, the mobile device 600 may include one or more of the following components: a processing component 602, a memory 604, a power component 606, a multimedia component 608, an audio component 610, an input/output (I/O) interface 612, a sensor component 614 and a communication component 616.

The processing component 602 generally controls the overall operation of the mobile device 600, such as operation associated with display, call, data communication, camera operation and recording operation. The processing component 602 may include one or more processors 620 for executing instructions to accomplish all of or part of the steps of the above methods for switching camera mode, specifically including: detecting an operation information of a user at an edge touch area of the mobile device in an on state of a camera of the mobile device; and switching the mode of the camera according to the operation information.

Moreover, the processing component 602 may include one or more modules, to facilitate the interaction between the processing component 602 and other components. For example, the processing component 602 may include a multimedia module, to facilitate the interaction between the multimedia component 608 and the processing component 602.

The memory 604 is configured to store various types of data to support the operation of the mobile device 600. The data examples include instructions, contact data, telephone directory data, messages, pictures, videos and the like of any application program or method operated on the mobile device 600. The memory 604 may be realized by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power component 606 provides power for various components of the mobile device 600. The power component 606 may include a power management system, one or more power supplies, and other components associated with power generation, management and distribution for the mobile device 600.

The multimedia component 608 includes a screen for providing an output interface between the mobile device 600 and the user. In some embodiments, the screen may include a liquid crystal display (LCD) and a touch panel (TP). If the screen includes the touch panel, the screen may be realized as a touch screen to receive input signals from the user. The touch panel includes one or more touch sensors for sensing touch, sliding and gestures on the touch panel. The touch sensors can not only sense the boundary of the touch or sliding action, but also detect the duration and the pressure related to the touch or sliding operation. In some embodiments, the multimedia component 608 includes a front camera and/or a rear camera. When the mobile device 600 is in an operation mode, e.g., a shooting mode or a video mode, the front camera and/or the rear camera can receive external multimedia data. Each of the front camera and the rear camera may be a fixed optical lens system or has focal length and optical zooming capability.

The audio component 610 is configured to output and/or input audio signals. For example, the audio component 610 includes a microphone (MIC), and when the mobile device 600 is in an operation mode, e.g., a call mode, a recording mode and a speech recognition mode, the microphone is configured to receive external audio signals. The received audio signals can be further stored in the memory 604 or sent by the communication component 616. In some embodiments, the audio component 610 further includes a loudspeaker for outputting audio signals.

The I/O interface 612 provides an interface between the processing component 602 and a peripheral interface module, and the peripheral interface module may be a keyboard, a click wheel, a button and the like. The button may include but not limited to a home page button, a volume button, a start button and a locking button.

The sensor component 614 includes one or more sensors for providing state assessment on all aspects for the mobile device 600. For example, the sensor component 614 may detect an on/off state of the mobile device 600, and relative positions of components, e.g., the components are a display and a small keyboard of the mobile device 600; and the sensor component 614 may also detect the position change of the mobile device 600 or one component of the mobile device 600, existence or no existence of contact between the user and the mobile device 600, orientation or acceleration/deceleration of the mobile device 600 and temperature change of the mobile device 600. The sensor component 614 may include a proximity sensor, which is configured to detect the presence of nearby objects in the absence of any physical contact. The sensor component 614 may further include an optical sensor, e.g., a CMOS or CCD image sensor used in imaging application. In some embodiments, the sensor component 614 may further include an acceleration sensor, a gyro sensor, a magnetic sensor, a pressure sensor or a temperature sensor.

The communication component 616 is configured to facilitate the communication between the mobile device 600 and other device in a wired or wireless mode. The mobile device 600 may be connected to a wireless network based on communication standards, e.g., Wi-Fi, 2G, 3G or 4G or their combination. In an exemplary embodiment, the communication component 616 receives broadcast signals or related broadcast information from an external broadcast management system via a broadcast channel. In an exemplary embodiment, the communication component 616 further includes a near field communication (NFC) module for promoting short-distance communication. For example, the NFC module may be realized on the basis of radio frequency identification (RFID) technology, infrared data association (IrDA) technology, ultra wide band (UWB) technology, Bluetooth (BT) technology or other technologies.

In an exemplary embodiment, the mobile device 600 may be realized by one or more application specific integrated circuits (ASICs), digital signal processors (DSPs), digital signal processing devices (DSPDs), programmable logic devices (PLDs), field-programmable gate arrays (FPGAs), controllers, microcontrollers, microprocessors or other electronic elements, to execute the above methods.

The mobile device of the embodiment of the present disclosure can execute the aforementioned methods for switching camera mode, and the mode of the camera of the mobile device can be switched by one operation action of the user at the edge touch area of the mobile device, so the operation process is simple and fast, the switching speed is improved, then the use experience of the user is promoted, and the user satisfaction is improved.

Those skilled in the art can clearly learn that for the purposes of convenience and conciseness of description, reference may be made to the corresponding processes in the aforementioned method embodiments as to the specific working processes of the above-described systems, apparatuses and modules, which are not redundantly described herein.

In the several embodiments provided by the present disclosure, it should be understood that the disclosed systems, apparatuses and methods may be realized in other ways. For example, the above-described device embodiments are only schematic, for example, the division of the modules is only a logical function division, and can have additional division ways in practice, for example, a plurality of modules or components may be combined or integrated to the other system, or some features may be ignored or not executed. In addition, the displayed or discussed mutual coupling or direct coupling or communication connection may be realized by indirect coupling or communication connection of some interfaces, apparatuses or modules, and may be in electrical, mechanical or other forms.

The modules illustrated as separate components may be or may not be physically separated, and the components displayed as modules may be or may not be physical modules, that is to say, the components may be positioned at one place or may also be distributed on a plurality of network units. The objectives of the solutions of the embodiments may be fulfilled by selecting part of or all of the modules according to actual needs.

In addition, the functional modules in the embodiments of the present disclosure may be integrated in one processing unit, or the modules exist separately and physically, or two or more modules are integrated in one unit. The integrated unit may be realized in the form of hardware or in the form of hardware and software functional units.

The integrated unit realized in the form of software functional units may be stored in a computer readable storage medium. The software functional units are stored in one storage medium, which includes a plurality of instructions enabling a computer device (which may be a personal computer, a server, or a network device or the like) or a processor to execute part of the steps of the method in each embodiment of the present disclosures. The aforementioned storage medium includes various media capable of storing program codes, such as a U disk, a mobile hard disk, a read-only memory (ROM), a random access memory (RAM), a magnetic disk or an optical disk.

The above descriptions are merely preferred embodiments of the present disclosure, and are not used for limiting the present disclosure. Any modification, equivalent substitution, improvement and the like made within the spirit and principle of the present disclosure shall be included within the protection scope of the present disclosure.

What is claimed is:

1. A method for switching camera mode, applied to a mobile device, comprising:
detecting an operation information of a user at an edge touch area of the mobile device in an on state of a camera of the mobile device; and
switching the mode of the camera according to the operation information.

2. The method for switching camera mode according to claim 1, wherein the switching the mode of the camera according to the operation information comprises:
under the condition that the operation information is a touch at a preset position of the edge touch area by the user, switching the camera to the mode corresponding to the preset position according to the touch.

3. The method for switching camera mode according to claim 1, wherein the switching the mode of the camera according to the operation information comprises:
under the condition that the operation information is sliding of a finger at the edge touch area, switching the camera to a next or last adjacent mode of a current mode according to the sliding.

4. The method for switching camera mode according to claim 3, wherein the sliding is up-down sliding of the thumb at the edge touch area of the left border or the right border of the mobile device.

5. The method for switching camera mode according to claim 3, wherein the sliding is left-right sliding of the index finger at the edge touch area of the upper border of the mobile device.

6. The method for switching camera mode according to claim 1, wherein the edge touch area is located at the side border of the mobile device.

7. A mobile device, comprising:
a processor; and
a memory which is used for storing instructions executable by the processor;
the processor is configured to:
detect an operation information of a user at an edge touch area of the mobile device in an on state of a camera of the mobile device; and
switch the mode of the camera according to the operation information.

8. The mobile device according to claim 7, wherein the mobile device is a mobile phone or a tablet computer.

9. The mobile device according to claim 7, wherein the switching the mode of the camera according to the operation information comprises:
under the condition that the operation information is a touch at a preset position of the edge touch area by the user, switching the camera to the mode corresponding to the preset position according to the touch.

10. The mobile device according to claim 7, wherein the switching the mode of the camera according to the operation information comprises:
under the condition that the operation information is sliding of the finger at the edge touch area, switching the camera to a next or last adjacent mode of a current mode according to the sliding.

11. The mobile device according to claim 9, wherein the sliding is up-down sliding of the thumb at the edge touch area of the left border or the right border of the mobile device.

12. The mobile device according to claim 9, wherein the sliding is left-right sliding of the index finger at the edge touch area of the upper border of the mobile device.

13. The mobile device according to claim 7, wherein the edge touch area is located at the side border of the mobile device.

14. A non-transient computer readable storage medium, wherein the non-transient computer readable storage medium stores computer executable instructions, which are used for:
detecting an operation information of a user at an edge touch area of the mobile device in an on state of a camera of the mobile device; and
switching the mode of the camera according to the operation information.

15. The non-transient computer readable storage medium according to claim 14, wherein the switching the mode of the camera according to the operation information comprises:
under the condition that the operation information is a touch at a preset position of the edge touch area by the user, switching the camera to the mode corresponding to the preset position according to the touch.

16. The non-transient computer readable storage medium according to claim 14, wherein the switching the mode of the camera according to the operation information comprises:
under the condition that the operation information is sliding of the finger at the edge touch area, switching the camera to a next or last adjacent mode of a current mode according to the sliding.

17. The non-transient computer readable storage medium according to claim 16, wherein the sliding is up-down sliding of the thumb at the edge touch area of the left border or the right border of the mobile device.

18. The non-transient computer readable storage medium according to claim 16, wherein the sliding is left-right sliding of the index finger at the edge touch area of the upper border of the mobile device.

19. The non-transient computer readable storage medium according to claim 14, wherein the edge touch area is located at the side border of the mobile device.
